(19) United States
(12) Patent Application Publication
(10) Pub. No.: US 2022/0012638 A1
(43) Pub. Date: Jan. 13, 2022

(54) USER SCORE PREDICTION METHOD, DEVICE, AND SYSTEM FOR PREDICTING USER SCORE THROUGH MULTI-DIMENSIONAL PAIRWISE COMPARISON

(71) Applicant: RIIID INC., Seoul (KR)

(72) Inventors: Hyun Bin LOH, Seoul (KR); Pil Jae CHAE, Seoul (KR); Chan You HWANG, Seoul (KR)

(21) Appl. No.: 17/372,305

(22) Filed: Jul. 9, 2021

(30) Foreign Application Priority Data
Jul. 10, 2020 (KR) 10-2020-0085519
Aug. 18, 2020 (KR) 10-2020-0102978

(51) Int. Cl. G06N 20/00; G06N 5/04; G06F 16/22

(52) U.S. Cl. CPC G06N 20/00; G06F 16/2264; G06N 5/04

(57) ABSTRACT

Provided is a user score prediction device capable of reducing the amount of data used and increasing a prediction speed by predicting a score using only response comparison information obtained by mutually comparing responses of a plurality of users according to an embodiment of the present disclosure.

The user score prediction device for predicting a score of a user through multi-dimensional pairwise comparison according to an embodiment of the present disclosure includes a question solving information collection unit that provides a question to be solved to a user through a user terminal and collects question solving information solved by the user, a response comparison information generation unit that generates response comparison information by performing multi-dimensional pairwise comparison between question solving data of a new user and question solving data of a reference user, and a score prediction unit that inputs the response comparison information to an artificial intelligence (AI) model trained in advance by response comparison information between arbitrary users and test scores to predict a score of the new user, and transmits the predicted score to a user terminal of the new user.

### CROSS REFERENCE TO RELATED APPLICATION

This application claims priority from Korean Patent Application No. 10-2020-0085519 filed on Jul. 10, 2020 and Korean Patent Application No. 10-2020-0102978 filed on Aug. 18, 2020 in the Korean Intellectual Property Office, the disclosure of which is incorporated herein by reference in its entirety.

### BACKGROUND OF THE INVENTION

### 1. Field of the Invention

The present disclosure relates to a user score prediction method, device, and system for predicting a user score by inputting response comparison information obtained by multi-dimensional pairwise comparison between a new user and a reference user to a trained artificial intelligence (AI) model.

### 2. Description of the Related Art

Recently, the Internet and electronic devices have been actively utilized in each field, and the educational environment has been rapidly changing. Especially, with the development of various educational media, learners can choose and use a wider range of learning methods. Among the methods, an education service through the Internet has become a major teaching and learning method due to advantages of overcoming time and space constraints and enabling low-cost education.

In response to this trend, customized education services, which have not been possible in offline education due to limited human and material resources, are also diversifying. For example, by using artificial intelligence to provide segmented educational content according to the individuality and ability of a learner, the educational content is provided according to the individual competency of the learner, breaking away from the uniform education method of the past.

However, the existing AI-based prediction method requires a large amount of training data and requires a lot of cost to infer a prediction result to achieve high performance. Question information and response information of a user for the question need to be trained one by one in an AI model, and for high performance, various data such as a time taken to solve the question and a probability of dropping out during learning may be additionally required.

In addition, unlike a probability of a correct answer that can be predicted directly from the question solving data allowed to be collected by the AI model, actual test score data for directly predicting a test score or grade is insufficient, and such data can only be collected in a small amount offline. Thus, there has been a problem that the accuracy is inferior when compared to prediction of the probability of the correct answer.

### SUMMARY OF THE INVENTION

To solve the above-mentioned problem, the present disclosure can provide a user score prediction method, device, and system capable of reducing the amount of data used and increasing a prediction speed by predicting a score using only response comparison information obtained by mutual comparison of responses of a plurality of users instead of using all individual responses of users for a particular question.

In addition, the present disclosure can provide a user score prediction method, device, and system capable of predicting test scores with high accuracy using only a small amount of question solving information without collecting actual test scores of users one by one.

A user score prediction device capable of reducing the amount of data used and increasing a prediction speed by predicting a score using only response comparison information obtained by mutually comparing responses of a plurality of users according to an embodiment of the present disclosure is a user score prediction device for predicting a score of a user through multi-dimensional pairwise comparison, including a question solving information collection unit that provides a question to be solved to users through user terminals and collects question solving information solved by the users, a response comparison information generation unit that generates response comparison information by performing multi-dimensional pairwise comparison between question solving data of a new user and question solving data of a reference user, and a score prediction unit that inputs the response comparison information to an AI model trained in advance by response comparison information between arbitrary users and test scores to predict a score of the new user, and transmits the predicted score to a user terminal of the new user.

A method of operating a user score prediction device capable of reducing the amount of data used and increasing a prediction speed by predicting a score using only response comparison information obtained by mutually comparing responses of a plurality of users according to an embodiment of the present disclosure is a method of operating a user score prediction device for predicting a score of a user through multi-dimensional pairwise comparison, including training an AI model using question solving information of a plurality of users having test scores, generating response comparison information through multi-dimensional pairwise comparison for questions commonly solved by a reference user and a new user when the new user is introduced, predicting a score of the new user by inputting one or more response comparison information to the AI model, and transmitting the predicted score to a user terminal of the new user.

### BRIEF DESCRIPTION OF THE DRAWINGS

FIG. 1 is a diagram for description of a user score prediction system according to an embodiment of the present disclosure;

FIG. 2 is a diagram for description of an operation of training an AI model through multi-dimensional pairwise comparison according to an embodiment of the present disclosure;

FIG. 3 is a diagram for description of an operation of predicting a score of a new user by using an AI model trained through multi-dimensional pairwise comparison according to an embodiment of the present disclosure;

FIG. 4 is a diagram for detailed description of a configuration of question solving information according to an embodiment of the present disclosure;

FIG. 5 is a diagram for description of a user information table according to an embodiment of the present disclosure;

FIG. 6 is a diagram for description of a user information table filtered based on a reference user according to an embodiment of the present disclosure;

FIG. 7 is a diagram for description of a response comparison information table generated through multi-dimensional pairwise comparison among a plurality of users according to an embodiment of the present disclosure;

FIG. 8 is a flowchart for description of an operation of predicting a score of a new user through multi-dimensional pairwise comparison according to an embodiment of the present disclosure; and

FIG. 9 is a flowchart for description of predicting the score of the new user of FIG. 8 in more detail.

### DESCRIPTION OF THE PREFERRED EMBODIMENTS

Hereinafter, embodiments disclosed in the present specification will be described in detail with reference to the accompanying drawings. However, the same or similar components are assigned the same reference symbols regardless of reference symbols, and redundant description thereof will be omitted.

In the description of the embodiments disclosed herein, when a component is referred to as being “coupled” or “connected” to another component, it should be understood that the component may be directly coupled or connected to the other component, or another component may exist in between.

In addition, in describing the embodiments disclosed in the present specification, when it is determined that detailed description of a related known technology may obscure the gist of the embodiments disclosed in the present specification, the detailed description thereof will be omitted. In addition, the accompanying drawings are only for easy understanding of the embodiments disclosed in the present specification, the technical idea disclosed herein is not limited by the accompanying drawings, and it should be understood to include all modifications, equivalents or substitutes included in the spirit and scope of the present disclosure.

The embodiments of the present disclosure disclosed in the present specification and drawings are merely provided for specific examples to easily describe the technical content of the present disclosure and help the understanding of the present disclosure, and are not intended to limit the scope of the present disclosure. It will be apparent to those of ordinary skill in the art to which the present disclosure pertains that other modifications based on the technical spirit of the present disclosure can be implemented in addition to the embodiments disclosed herein.

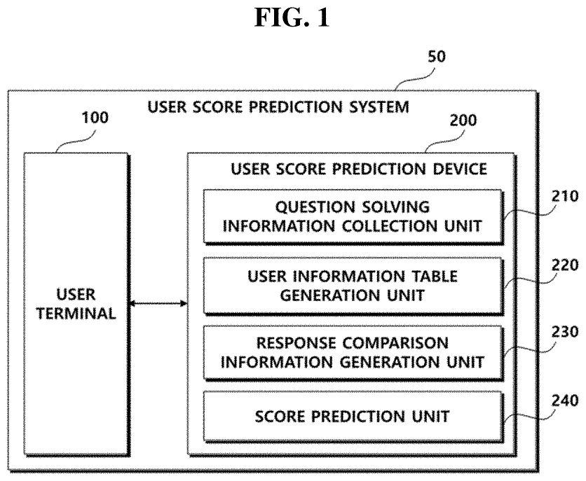

FIG. 1 is a diagram for description of a user score prediction system according to an embodiment of the present disclosure.

Referring to FIG. 1, a user score prediction system 50 may include a user terminal 100 and a user score prediction device 200.

The user score prediction system 50 may collect question solving data of a plurality of users then train an AI model, and predict a score of a new user based on the trained AI model.

Question solving data of an existing reference user and question solving data of a new user may be subjected to multi-dimensional pairwise comparison to generate response comparison information. The response comparison information may be information indicating a relative ability in a numerical expression by comparing responses to questions commonly solved by the reference user and the new user.

The response comparison information may include the number of questions correctly answered by both user 1 and user 2 (TT), the number of questions correctly answered only by user 1 (TF), the number of questions correctly answered only by user 2 (FT), and the number of questions incorrectly answered by both users (FF). However, the response comparison information may include comparison information on questions having similarity within a preset range as well as comparison information on the exact same question.

For example, when user 1 solves question 23 and user 2 solves question 31, and question 23 and question 31 have similarity within a preset range and are determined to be of similar difficulty or similar type, it is considered that the same question is solved, and this information can be reflected in the response comparison information.

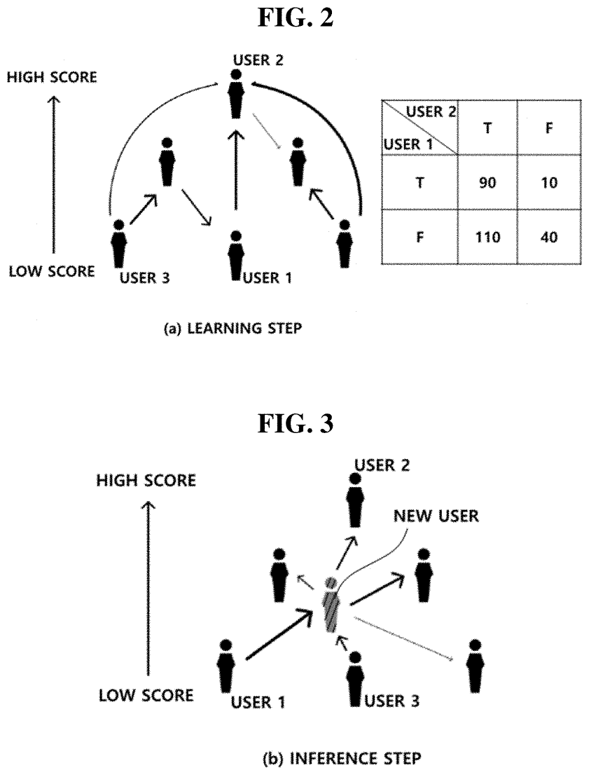

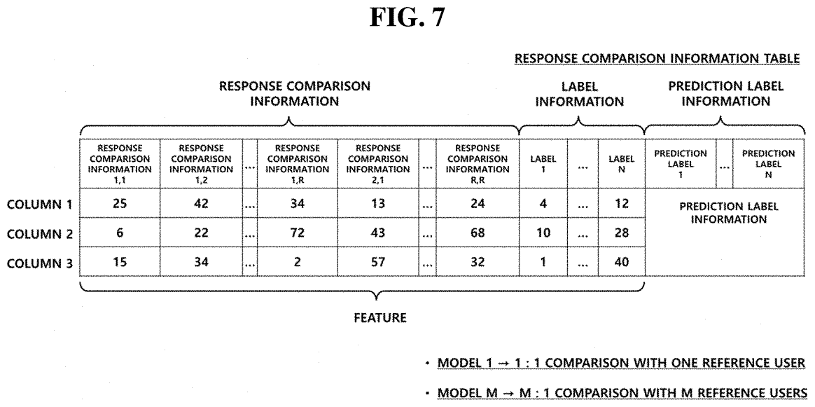

The response comparison information will be described in more detail with reference to FIGS. 2 and 7 to be described later.

There have been various attempts to predict a user score through AI in the conventional education field. Existing evaluation methods include a knowledge-based graph, content tagging, a domain expert-based method, or a method of predicting test scores by training questions and user responses on an AI model of a deep neural network. However, the above conventional methods have the following questions.

The existing AI-based prediction method including a neural network model requires a large amount of training data and requires a lot of cost to infer a prediction result to achieve high performance. Question information and response information of a user for the question need to be trained one by one in an AI model, and for high performance, various data such as a time taken to solve the question and a probability of dropping out during learning may be additionally required.

The domain expert-based method has less complexity and can reduce operating costs. However, the cost of separately paying a domain expert to develop such a domain expert-based method is excessive. Accordingly, there is a problem in terms of cost that it is difficult to provide a high-quality service to users at low cost.

To do solve such a problem, the user score prediction system 50 according to the embodiment of the present disclosure predicts a score by using only response comparison information in which responses of a plurality of users are compared with each other instead of using all individual responses of users to a specific question.

To this end, the user score prediction system 50 may include the user terminal 100 and the user score prediction device 200. The user score prediction device 200 may include a question solving information collection unit 210, a user information table generation unit 220, a response comparison information generation unit 230, and a score prediction unit 240.

The question solving information collection unit 210 may provide a question to be solved to users through the user terminal 100 and collect question solving information on the question solved by the users.

The question solving information collected by the question solving information collection unit 210 may be used as training data for training the AI model, used to generate a filtered user information table for generating response comparison information through the user information table generation unit 220, or used as a feature for predicting a score by collecting question solving information from a new user.

The question solving information of the plurality of users having test scores collected by the question solving information collection unit 210 may be used for training of the AI model. After that, when response comparison information is input as a feature for predicting a score to the trained AI model, the input response comparison information may be used to predict a score of a new user.

The user information table generation unit 220 may analyze the question solving information of the users collected by the question solving information collection unit 210 to generate a table in a preset format. Thereafter, the user information table generation unit 220 may generate a filtered user information table by filtering the user information table with reference users.

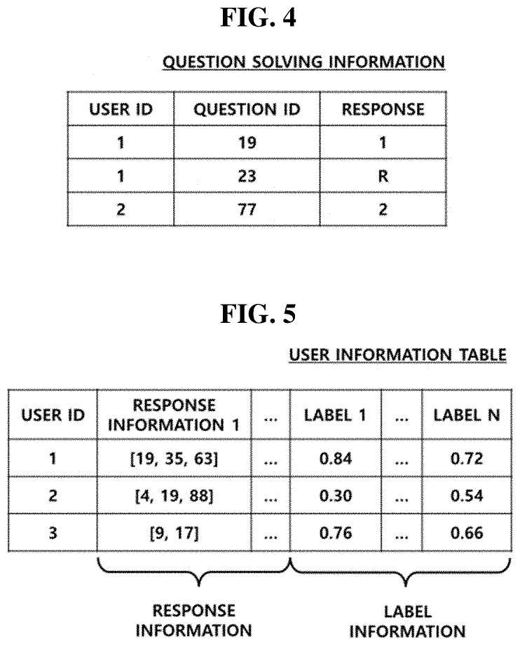

An operation of the user information table generation unit 220 will be described in more detail with reference to FIGS. 4 to 6 to be described later.

The response comparison information generation unit 230 may generate response comparison information by performing multi-dimensional pairwise comparison between the question solving data of the new user and the question solving data of the reference users, which can be described as generating response comparison information by performing multi-dimensional pairwise comparison of the question solving data of the new user with each column of the filtered user information table one by one in FIG. 7 to be described later.

The reference user may be a user serving as a standard for comparison with the question solving data of the new user when generating the response comparison information.

The reference user may be determined in advance according to a predetermined criterion. For example, since the response comparison information is generated for a question commonly solved by the reference user and the new user, it is preferable that questions solved by the new user are included as many as possible in the question solving information of the reference user.

Accordingly, a preset number of users in descending order of the number of solved questions may be determined as reference users so that more questions solved by the new user can be included in the question solving information of the reference user.

Alternatively, a user solving a certain number or more of questions may be determined as a reference user, or an optimal user group may be determined as a reference user based on a result of predicting a score by selecting an arbitrary user group as a reference user. The determination of the reference user is not limited thereto, and the reference user may be determined in various ways according to embodiments.

The score prediction unit 240 may predict a score of a new user by inputting response comparison information of the new user to an AI model pre-trained using response comparison information between arbitrary users and test scores. Alternatively, the score prediction unit 240 may predict a score of a new user by inputting label information of a reference user together with response comparison information to an AI model.

The score prediction unit 240 may predict the score of the new user based on prediction label information. Either model 1 or model M may be used to predict the score of the new user.

Model 1 is a model that predicts a score using only prediction label information generated through one-to-one comparison with one reference user.

Model 1 predicts a score using prediction labels 1 to N corresponding to one column, and thus has an advantage in that a prediction speed is fast and required model performance is low. However, since only response comparison information with one reference user is used, the model has a disadvantage in terms of accuracy.

Model M is a model that predicts a score using prediction label information generated through M-to-one comparison with M reference users.

Model M uses N*M prediction labels compared with M reference users, and thus has an advantage over Model 1 in terms of accuracy. However, there is a disadvantage in that as M increases, required performance increases and a time required for prediction increases.

The score prediction unit 240 according to the embodiment of the present disclosure may determine one of model 1 or M to be used depending on the operating environment, such as the type of test, the performance of the hardware, the required prediction accuracy, the performance of the trained AI, the number of questions solved by a new user, or the number of reference users. Furthermore, even when model M is used, the number M of reference users may be determined differently.

Hereinafter, a detailed operation of the multi-dimensional pairwise comparison will be described with reference to FIGS. 2 and 3.

FIG. 2 is a diagram for description of an operation of training an AI model through multi-dimensional pairwise comparison according to the embodiment of the present disclosure.

Referring to FIG. 2, respective users illustrated in FIG. 2 may exist as reference users. When a new user is introduced, each user may be compared with the new user through multi-dimensional pairwise comparison and used to predict a score of the new user.

Arrows between users indicate a result of multi-dimensional pairwise comparison. User 2 is determined to have a higher score than user 1, so the arrow points to user 2.

Multi-dimensional pairwise comparison may not be allowed between specific users, so an arrow may not be formed. When there is no common question solved by user 1 and user 3, or when each item of the response comparison information between user 1 and user 3 is the same, for example, when the number of questions correctly answered by both user 1 and user 3 (TT) is 50, the number of questions correctly answered only by user 1 (TF) is 50, the number of questions correctly answered only by user 3 (FT) is 50, and the number of questions incorrectly answered by both user 1 and user 3 (FF) is 50, abilities of user 1 and user 3 may not be compared only by the response comparison information. Thus, in this case, an arrow may not be formed.

Multi-dimensional pairwise comparison according to an embodiment of the present disclosure will be described below using user 1 and user 2 as an example. Response comparison information of user 1 and user 2 is illustrated in a right table of FIG. 2.

According to the response comparison information, the number of questions correctly answered by both user 1 and user 2 is 90, the number of questions correctly answered only by user 1 is 10, the number of questions correctly answered only by user 2 is 110, and the number of questions incorrectly answered by both the users is 40.

In this instance, it can be understood that user 1 correctly answers 45% ({(90/(90+110)}*100)) of 200 questions correctly answered by user 2, and user 2 correctly answers 90% ({(90/(90+10)}*100)) of 100 questions correctly answered by user 1. In other words, knowledge of user 2 includes knowledge of user 1, and as a result, it can be determined that user 2 may obtain a higher score than that of user 1 in a test.

FIG. 3 is a diagram for description of an operation of predicting a score of a new user by using an AI model trained through multi-dimensional pairwise comparison according to an embodiment of the present disclosure.

FIG. 3 illustrates that the new user indicated by hatching is introduced into the trained AI model. The new user may be compared with each user through multi-dimensional pairwise comparison. Comparison results are indicated by arrows with each user. Result of comparing the new user with user 1, user 2, and user 3 will be described as an example.

As a result of multi-dimensional pairwise comparison of the new user and user 1, it may be determined that the new user includes knowledge of user 1. Accordingly, the arrow is illustrated to point from user 1 to the new user.

As a result of multi-dimensional pairwise comparison of the new user and user 2, it may be determined that user 2 includes knowledge of the new user. Accordingly, the arrow is illustrated to point from the new user to user 2.

As a result of multi-dimensional pairwise comparison of the new user and user 3, it may be determined that the new user includes knowledge of user 3. Accordingly, the arrow is illustrated to point from user 3 to the new user.

In this way, the new user can be subjected to multi-dimensional pairwise comparison with each comparable user to find a relative position thereof in relation to other users. The relative position of the new user can be converted into a score, and as a result, the score of the new user can be predicted.

FIG. 4 is a diagram for detailed description of a configuration of question solving information according to an embodiment of the present disclosure.

Referring to FIG. 4, question solving information may include user ID, question ID, and response. Each time a user solves a question, the user score prediction device 200 can match the user ID indicating a user solving a question, a question ID indicating the question solved by the user, and a response which is a result of a solution of the user to the question, and collect the user ID, the question ID, and the response as the question solving information.

FIG. 5 is a diagram for description of a user information table according to an embodiment of the present disclosure.

Referring to FIG. 5, the user score prediction device 200 may generate a user information table by analyzing the collected question solving information. The user information table may include user ID, response information, and label information.

The response information may be information that groups questions having the same user response. For example, response information 1 may be information that groups IDs of questions to which the user responds with 1. Response information 2 may be information that groups IDs of questions to which the user responds with 2. Similarly, response information R may be information that groups IDs of questions to which the user responds with R. In the embodiment of FIG. 5, since response information 1 is [19, 35, 63], it can be understood that the questions to which the user 1 responds with 1 are questions #19, #35, and #63.

The label information may be information numerically expressing a learning ability of the user. The label information may be information expressing a probability that a user will correctly answer a question.

In the embodiment of FIG. 5, when there are questions #1 to #N, it can be understood that a probability that user 1 whose user ID is ‘1’ will correctly answer question #1 may be 0.84, . . . , a probability that user 1 will correctly answer question #N may be 0.72. A probability that user 2 whose user ID is ‘2’ will correctly answer question #1 may be 0.30, . . . , a probability that user 2 will correctly answer question #N may be 0.54. A probability that user 3 whose user ID is ‘3’ will correctly answer question #1 may be 0.76, . . . , a probability that user 3 will correctly answer question #N may be 0.66.

The user information table is arranged in a lookup table format by matching a user ID with response information and label information, and can be used thereafter to generate response comparison information by performing multi-dimensional pairwise comparison with response information and label information of a new user.

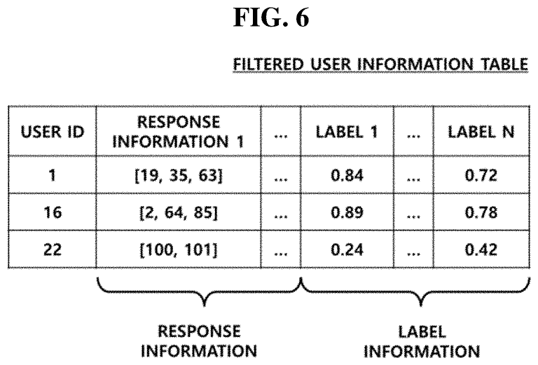

FIG. 6 is a diagram for description of a user information table filtered based on a reference user according to an embodiment of the present disclosure.

Referring to FIG. 6, the user score prediction system 50 may generate a filtered user information table by filtering the user information table of FIG. 5 with predetermined reference users. The filtered user information table is a subset of the user information table, and may include only response information and label information of the reference users.

The reference user may be a user serving as a standard for comparison with question solving data of a new user when generating response comparison information.

The reference user may be determined in advance according to a predetermined criterion. For example, since the response comparison information is generated for a question commonly solved by the reference user and the new user, it is preferable that questions solved by the new user are included as many as possible in question solving information of the reference user.

Accordingly, a certain number of users may be determined as reference users in descending order of the number of solved questions so that more questions solved by the new user may be included in the question solving information of the reference user.

Alternatively, a user solving a certain number or more of questions may be determined as a reference user, or an optimal user group may be determined as a reference user based on a result of predicting a score by selecting an arbitrary group as a reference user. The determination of the reference user is not limited thereto, and the reference user may be determined in various ways according to embodiments.

The embodiment of FIG. 6 illustrates that the reference users are user 1 whose user ID is ‘1’, user 16 whose user ID is ‘16’, and user 22 whose user ID is ‘22’. The figure illustrates that the user information table is filtered by user 1, user 16, and user 22, and response information and label information of the remaining users are omitted.

FIG. 7 is a diagram for description of a response comparison information table generated through multi-dimensional pairwise comparison among a plurality of users according to an embodiment of the present disclosure.

Referring to FIG. 7, the response comparison information table may include response comparison information, label information, and prediction label information. The response comparison information may be information representing a relative ability in a numerical expression by performing a multi-dimensional pairwise comparison of responses to questions commonly solved by a new user and a reference user.

In the embodiment of FIG. 7, column 1 may be a result of multi-dimensional pairwise comparison between reference user 1 and the new user. Column 2 may be a result of multi-dimensional pairwise comparison between reference user 2 and the new user. Column 3 may be a result of multi-dimensional pairwise comparison between reference user 3 and the new user.

In column 1, response comparison information 1, 1 may indicate the number of questions to which both the new user and reference user 1 respond with 1. Response comparison information 1, 2 may indicate the number of questions to which the new user responds with 1 and reference user 1 responds with 2. Response comparison information 1, R may indicate the number of questions to which the new user responds with 1 and reference user 1 responds with R. Response comparison information 2, 1 may indicate the number of questions to which the new user responds with 2 and reference user 1 responds with 1. Response comparison information R, R may indicate the number of questions to which both the new user and reference user 1 respond with R.

In column 2, response comparison information 1, 1 may indicate the number of questions to which both the new user and reference user 2 respond with 1. Response comparison information 1, 2 may indicate the number of questions to which the new user responds with 1 and reference user 2 responds with 2. Response comparison information 1, R may indicate the number of questions to which the new user responds with 1 and reference user 2 responds with R. Response comparison information 2, 1 may indicate the number of questions to which the new user responds with 2 and reference user 2 responds with 1. Response comparison information R, R may indicate the number of questions to which both the new user and reference user 2 respond with R.

In column 3, response comparison information 1, 1 may indicate the number of questions to which both the new user and reference user 3 respond with 1. Response comparison information 1, 2 may indicate the number of questions to which the new user responds with 1 and reference user 3 responds with 2. Response comparison information 1, R may indicate the number of questions to which the new user responds with 1 and reference user 3 responds with R. Response comparison information 2, 1 may indicate the number of questions to which the new user responds with 2 and reference user 3 responds with 1. Response comparison information R, R may indicate the number of questions to which both the new user and reference user 3 respond with R.

The label information may be information numerically expressing a learning ability of the reference user. The label information may be information expressing a probability that the reference user will correctly answer a question.

Column 1 may be information indicating a learning ability of reference user 1. Specifically, label 1 in column 1 may indicate a probability that reference user 1 will correctly answer question 1, label 2 in column 1 may indicate a probability that reference user 1 will correctly answer question 2, . . . , label N in column 1 may indicate a probability that reference user 1 will correctly answer question N, respectively.

Column 2 may be information indicating a learning ability of reference user 2. Specifically, label 1 in column 2 may indicate a probability that reference user 2 will correctly answer question 1, label 2 in column 2 may indicate a probability that reference user 2 will correctly answer question 2, . . . , label N in column 2 may indicate a probability that reference user 2 will correctly answer question N, respectively.

Column 3 may be information indicating a learning ability of reference user 3. Specifically, label 1 in column 3 may indicate a probability that reference user 3 will correctly answer question 1, label 2 in column 3 may indicate a probability that reference user 3 will correctly answer question 2, . . . , label N in column 3 may indicate a probability that reference user 3 will correctly answer question N, respectively.

The response comparison information and the label information may constitute a feature. The feature may be defined as an input of an AI model for inferring a prediction value. Based on the feature, the AI model outputs a predicted value by performing an inference process.

However, in the embodiment, the feature may include only response comparison information. The label information may be omitted from the feature, and only the response comparison information may be used as an input of the AI model to output prediction label information.

In this case, the data amount of the feature can be reduced, and thus the performance of the AI model can be improved. In addition, since the label information is a fixed value rather than a value that changes according to a new user, the effect on the prediction result is insignificant. Therefore, it is possible to improve the overall performance of the AI model by omitting the label information as a feature and using only the response comparison information.

The prediction label information may be information numerically expressing a learning ability of a new user. For example, the prediction label information may be information expressing a probability that the new user will correctly answer a question.

Specifically, prediction label 1 may indicate a probability that the new user will correctly answer question 1, prediction label 2 may indicate a probability that the new user will correctly answer question 2, . . . , prediction label N may indicate a probability that the new user will correctly answer question N.

Prediction labels may be independently generated for each reference user, that is, for each column. Prediction labels generated as a result of multi-dimensional pairwise comparison between the new user and reference user 1 may be generated in prediction labels 1 to N of column 1, prediction labels generated as a result of multi-dimensional pairwise comparison between the new user and reference user 2 may be generated in prediction labels 1 to N of column 2, and prediction labels generated as a result of multi-dimensional pairwise comparison between the new user and reference user 3 may be generated in prediction labels 1 to N of column 3, respectively.

The user score prediction device 200 may predict a score of a new user based on the prediction label information. Either model 1 or model M may be used to predict the score of the new user.

Model 1 is a model that predicts a score using only prediction label information generated through one-to-one comparison with one reference user.

Model 1 has an advantage in that a prediction speed is fast and required model performance is low since a score is predicted using prediction labels 1 to N corresponding to one column. However, since only response comparison information with one reference user is used, there is a disadvantage in terms of accuracy.

Model M is a model that predicts a score using prediction label information generated through M-to-one comparison with M reference users.

Model M uses N*M prediction labels compared with M reference users, and thus has an advantage over Model 1 in terms of accuracy. However, as M increases, required performance increases and a time required for prediction increases.

The user score prediction system 50 according to the embodiment of the present disclosure may determine one of model 1 or model M to be used depending on the operating environment, such as the type of test, the performance of the hardware, the required prediction accuracy, the performance of the trained AI, the number of questions solved by a new user, or the number of reference users. Furthermore, even when model M is used, the number M of reference users may be determined differently.

For example, in an operating environment where the required accuracy is low and fast prediction results are required, Model 1 or Model M, which requires a small number of reference users, may be used.

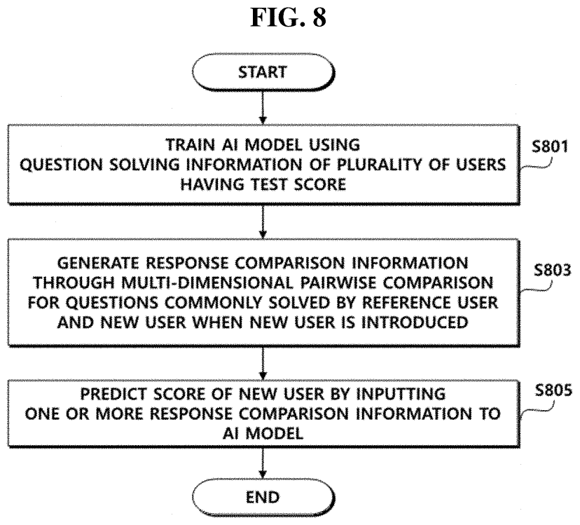

FIG. 8 is a flowchart for description of an operation of predicting a score of a new user through multi-dimensional pairwise comparison according to an embodiment of the present disclosure.

Referring to FIG. 8, in step S801, the user score prediction system 50 may train an AI model using question solving information of a plurality of users having test scores.

The question solving information of the plurality of users may be subjected to multi-dimensional pairwise comparison through the process of FIG. 2. As a result, response comparison information is generated, and the AI model can be trained based on the response comparison information and the test scores of the users.

In step S803, when a new user is introduced, the user score prediction system 50 may generate response comparison information through multi-dimensional pairwise comparison for questions commonly solved by the reference user and the new user.

The response comparison information can be used for score prediction, except for cases where there is no common question or each item (TT, TF, FT, and FF) of the response comparison information is the same so that the relative ability cannot be compared.

The response comparison information may be generated by performing multi-dimensional pairwise comparison between response information of the new user and response information of the reference user. The response comparison information may include information about the number of questions correctly answered by both the new user and the reference user (TT), the number of questions correctly answered only by the new user (TF), the number of questions correctly answered only by the reference user (FT), and the number of questions incorrectly answered by both the new user and the reference user (FF).

In step S805, the user score prediction system 50 may predict the score of the new user by inputting one or more response comparison information to the AI model. In this instance, the user score prediction system 50 may determine a model to be used for score prediction by differently controlling the number of reference users according to the operating environment. Model 1 is a model that predicts a score using only prediction label information generated through one-to-one comparison with one reference user. Model M is a model that predicts a score using prediction label information generated through M-to-one comparison with M reference users.

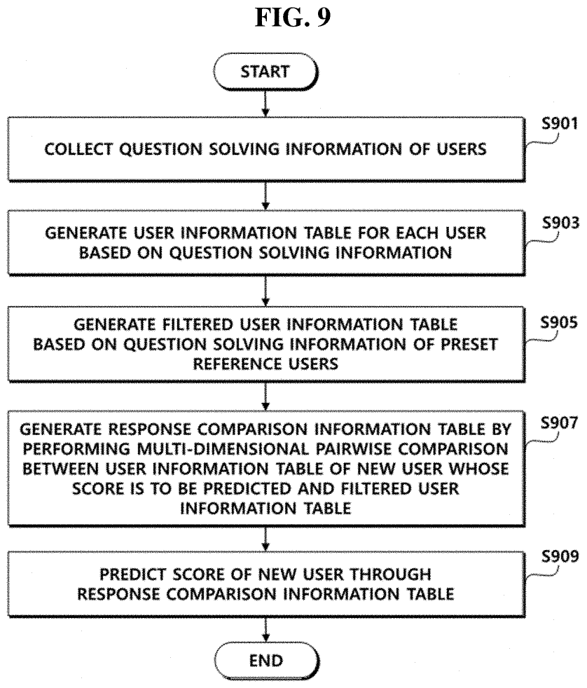

FIG. 9 is a flowchart for description of predicting the score of the new user of FIG. 8 in more detail.

Referring to FIG. 9, in step S901, the user score prediction system 50 may collect question solving information of users.

Question solving information may be used as training data for training the AI model, used to generate a filtered user information table for generating response comparison information, or used as a feature for predicting a score by collecting question solving information from a new user.

In step S903, the user score prediction system 50 may generate a user information table based on the collected question solving information of the users. The user information table may be a table in which user ID, response information, and label information are matched and stored in a lookup table format.

In step S905, the user score prediction system 50 may generate the filtered user information table based on question solving information of preset reference users. The filtered user information table is a subset of the user information table generated in step S903, and may be used to generate response comparison information by performing multi-dimensional pairwise comparison with a user information table of a new user.

In step S907, the user score prediction system 50 may generate a response comparison information table by performing multi-dimensional pairwise comparison between a user information table of a new user whose score is to be predicted and the filtered user information table.

Multi-dimensional pairwise comparison may be an operation of generating information about the number of questions correctly answered by two users (TT), the number of questions correctly answered only by one user (TF or FT), and the number of questions incorrectly answered by both the two users (FF) based on question solving data of the two users to be compared. The information may be included in the response comparison information.

In step S909, the user score prediction system 50 may predict the score of the new user through the response comparison information table.

A user score prediction method, device, and system according to an embodiment of the present disclosure can reduce the amount of data used and increase a prediction speed by predicting a score using only response comparison information obtained by mutual comparison of responses of a plurality of users instead of using all individual responses of users for a particular question.

In addition, a user score prediction method, device, and system according to an embodiment of the present disclosure can predict test scores with high accuracy using only a small amount of question solving information without collecting actual test scores of users one by one.

Embodiments of the present disclosure published in the present specification and drawings are merely presented as specific examples in order to easily describe the technical contents of the present disclosure and help the understanding of the present disclosure, and are not intended to limit the scope of the present disclosure. It will be apparent to those of ordinary skill in the art to which the present disclosure pertains that other modifications based on the technical spirit of the present disclosure may be implemented in addition to the embodiments disclosed herein.

What is claimed is:

1. A user score prediction device for predicting a score of a user through multi-dimensional pairwise comparison, the device comprising:
a question solving information collection unit that provides a question to be solved to users through user terminals and collects question solving information solved by the users;
a response comparison information generation unit that generates response comparison information by performing multi-dimensional pairwise comparison between question solving data of a new user and question solving data of a reference user; and
a score prediction unit that inputs the response comparison information to an artificial intelligence (AI) model trained in advance by response comparison information between arbitrary users and test scores to predict a score of the new user, and transmits the predicted score to a user terminal of the new user.

2. The device according to claim 1, further comprising
a user information table generation unit that generates a user information table matching response information and label information for each user ID based on question solving information of the users collected in the question solving information collection unit, wherein the response information being information grouping questions having the same user response, wherein the label information being information numerically expressing a learning ability of a user.

3. The device according to claim 2, wherein the user information table generation unit filters the user information table by the reference user determined in advance to generate a filtered user information table.

4. The device according to claim 3, wherein the reference user is a user serving as a standard for comparison with the question solving data of the new user when generating the response comparison information, and a preset number of users are determined as the reference user in descending order of the number of questions solved.

5. The device according to claim 4, wherein the response comparison information includes the number of questions correctly answered by both the new user and the reference user, the number of questions correctly answered only by the new user, the number of questions correctly answered only by the reference user, and the number of questions incorrectly answered by both the new user and the reference user.

6. The device according to claim 5, wherein the score prediction unit predicts the score of the new user by inputting the label information of the reference user together with the respond comparison information to the AI model.

7. A method of operating a user score prediction device for predicting a score of a user through multi-dimensional pairwise comparison, the method comprising:
training an AI model using question solving information of a plurality of users having test scores;
generating response comparison information through multi-dimensional pairwise comparison for questions commonly solved by a reference user and a new user when the new user is introduced;
predicting a score of the new user by inputting one or more response comparison information to the AI model; and
transmitting the predicted score to a user terminal of the new user.
